(19) United States
(12) Patent Application Publication
(10) Pub. No.: US 2003/0173753 A1
(43) Pub. Date: Sep. 18, 2003

(54) Pivot uplifting device for dolly

(76) Inventor: Juni Pong, El Monte, CA (US)

Correspondence Address: Raymond Y. CHAN, 1050 Oakdale Lane, Arcadia, CA, 91006, US

(21) Appl. No.: 10/098,062

(22) Filed: Mar. 15, 2002

(51) Int. Cl. B62B 1/10; B62B 5/00

(52) U.S. Cl. 280/47.27

(57) ABSTRACT

A pivot uplifting device incorporated with a dolly includes a pivot arm and a retaining unit rearwardly extended from a dolly frame to retain the pivot arm in a normal position and to guide the pivot arm to move at a pivot lifting position. In the normal position, the pivot is moved behind a ground platform of the dolly frame, and in the pivot lifting position, the pivot arm is moved underneath the ground platform, so that the pivot arm function as a pivot for the dolly frame pivotally lifting up an object on the ground platform.

### BACKGROUND OF THE PRESENT INVENTION

1. Field of Invention

The present invention relates to a dolly, and more particularly to a dolly incorporated with a pivot uplifting device which substantially shift a pivot point of the dolly closed to a center of weight of an object loaded thereon, so as to easily uplifting the dolly in a pivotal manner.

2. Description of Related Arts

A conventional dolly comprises a dolly frame having a handle portion, a supporting platform frontwardly extended from a bottom portion of the dolly frame and a wheel assembly rotatably mounted behind the supporting frame. The distinctive feature of the dolly is that the supporting platform, having a flat ground surface, is positioned relatively close to the ground for easily placing the supporting platform under an object so as to load the object on the supporting platform. Moreover, a user is able to apply a backward pulling force on the handle portion of the dolly frame so as to pivotally lift up the object at a pivot PI of the wheel assembly. However, the conventional dolly has several drawbacks.

Referencing to FIG. 4A, in the pivot lifting operation of the dolly, a downward force of the weight of the object is applied on the supporting platform to define an uplifting length D1 between the pivot P1 and the center of weight W of the object. According to the principle of lever, the user must apply a greater pulling force on the handle portion of the dolly frame in order to pivotally lift up the object. It is because the pivot pulling length which is defined between the pivot P1 and the pulling force F is greater than the uplifting length.

Moreover, in order to bendover or lift up the object, the user must pivotally rotate the dolly frame at the pivot with a predetermined pivot angle, referencing to FIG. 4B, in such a manner that the user must pivotally rotate the dolly frame with a predetermined control length D3 wherein the uplifting length is proportional to the pivot angle. In other words, by increasing the uplifting length, the user must pivotally rotate the dolly frame with a greater control distance.

In order to reduce the pulling force required to pivotally lift up the object by the dolly and enhance the control of the dolly frame, one of the most effective ways is to reduce the uplifting length D1. In other words, by shifting the pivot P1 from the wheel assembly toward the center of weight W of the object, the dolly will not only substantially reduce the uplifting length D1 but also minimize the control distance D3 of the dolly frame.

### SUMMARY OF THE PRESENT INVENTION

A main object of the present invention is to provide a pivot uplifting device for a dolly or hand truck, which substantially shifts a pivot point of the dolly closer to a center of weight of an object loaded on the dolly so as to facilitate the uplifting operation of the dolly with less effort.

Another object of the present invention is to provide a pivot uplifting device for a dolly or hand truck, wherein a pivot arm of the pivot uplifting device can be easily moved underneath a ground platform of the dolly and functioned as a pivot for substantially reduce a pivot uplifting length between the pivot arm and a center of weight of an object, so as to pivotally lifting up the object loaded on the ground platform.

Another object of the present invention is to provide a pivot uplifting device for a dolly or hand truck, wherein the pivot arm is normally retained behind the ground platform such that the pivot uplifting device will not interrupt the normal operation of the dolly while transporting the object.

Another object of the present invention is to provide a pivot uplifting device for a dolly or hand truck, which does not require altering the original structural design of the dolly, so that the pivot uplifting device can be installed in all kinds of hand truck or conventional dolly having a ground platform.

Accordingly, in order to achieve the above objects, the present invention provides a dolly comprising a pivot uplifting device.

The dolly comprises a dolly frame comprising a supporting frame, a handle frame rearwardly extended from an upper portion of the supporting frame, a ground platform, for loading a weight of an object thereon, frontwardly extended from a bottom portion of the supporting frame, and a wheel assembly rotatably mounted behind the supporting frame.

The pivot uplifting device comprises:

a pivot arm mounted to the dolly frame in a movable manner, wherein the pivot arm is adapted to move between a normal position and a pivot lifting position, wherein in the normal position, the pivot arm is moved behind the ground platform, and in the pivot lifting position, the pivot arm is moved underneath the ground platform, so that the pivot arm functions as a pivot of the dolly frame for pivotally lifting up the object on the ground platform; and

a retaining unit rearwardly extended from the dolly frame to retain the pivot arm in the normal position.

### BRIEF DESCRIPTION OF THE DRAWINGS

FIG. 1 is a rear perspective view of a dolly incorporated with a pivot uplifting device according to a first preferred embodiment of the present invention.

FIG. 2 is an exploded perspective view of the pivot uplifting device for the dolly according to the above first preferred embodiment of the present invention.

FIG. 3A is a side view of the pivot uplifting device for the dolly according to the above first preferred embodiment of the present invention, illustrating the pivot arm moved in a normal position.

FIG. 3B is a side view of the pivot uplifting device for the dolly according to the above first preferred embodiment of the present invention, illustrating the pivot arm moved in a pivot lifting position.

FIGS. 4A and 4B illustrate a side view of the dolly according to the above first preferred embodiment of the present invention, comparing with the conventional dolly.

FIG. 5 illustrates an alternative mode of a resilient element of the pivot uplifting device according to the above first preferred embodiment of the present invention.

FIG. 6 illustrates an alternative mode of a retaining unit of the pivot uplifting device according to the above first preferred embodiment of the present invention.

FIG. 7 is a perspective view of a pivot uplifting device for a dolly according to a second preferred embodiment of the present invention.

FIG. 8 is a side view of the pivot uplifting device for the dolly according to the second preferred embodiment of the present invention.

### DETAILED DESCRIPTION OF THE PREFERRED EMBODIMENT

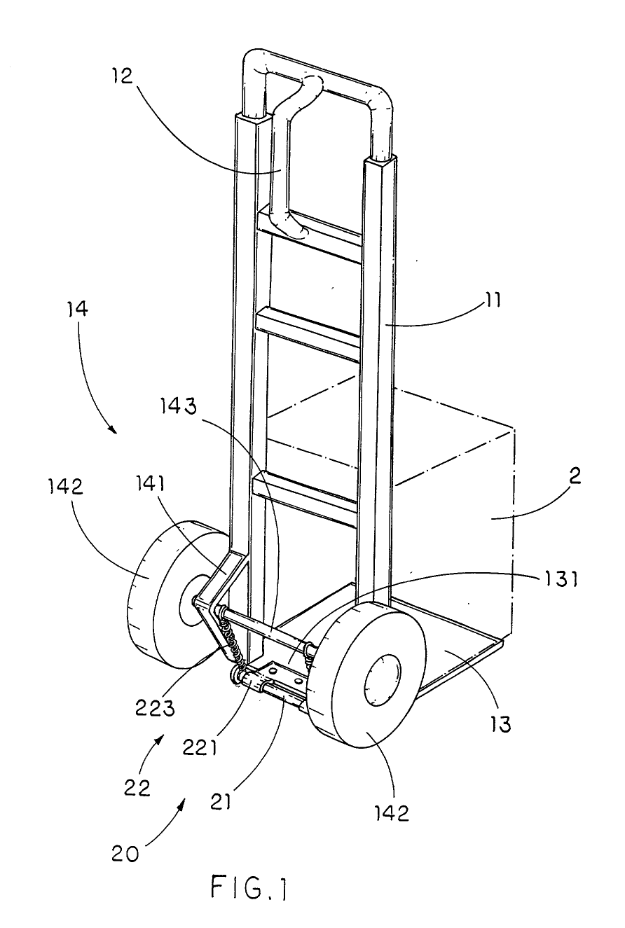

Referring to FIG. 1 of the drawings, a dolly 1 constructed with a pivot uplifting device 20 according to a first preferred embodiment of the present invention is illustrated. The dolly 1, such as a conventional dolly, comprises a dolly frame 10 comprising a supporting frame 11, a handle frame 12 rearwardly extended from an upper portion of the supporting frame 11, a ground platform 13 frontwardly extended from a bottom portion of the supporting frame 11, and a wheel assembly 14 rotatably mounted behind the supporting frame 11.

The wheel assembly 14 comprises a wheel frame 141 having a front end firmly connected to a rear side of the supporting frame 11 and a rear end rearwardly extended from the supporting frame 11, and a pair of dolly wheels 142 are rotatably mounted to the rear end of the wheel frame 141 via a wheel axle 143, so as to support the pair of dolly wheels behind the supporting frame 11.

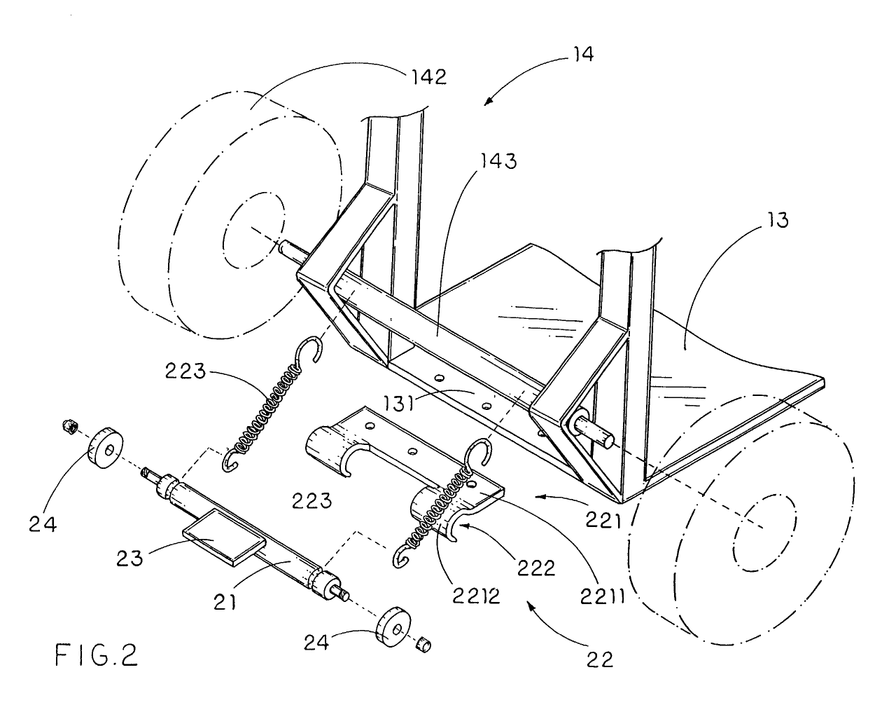

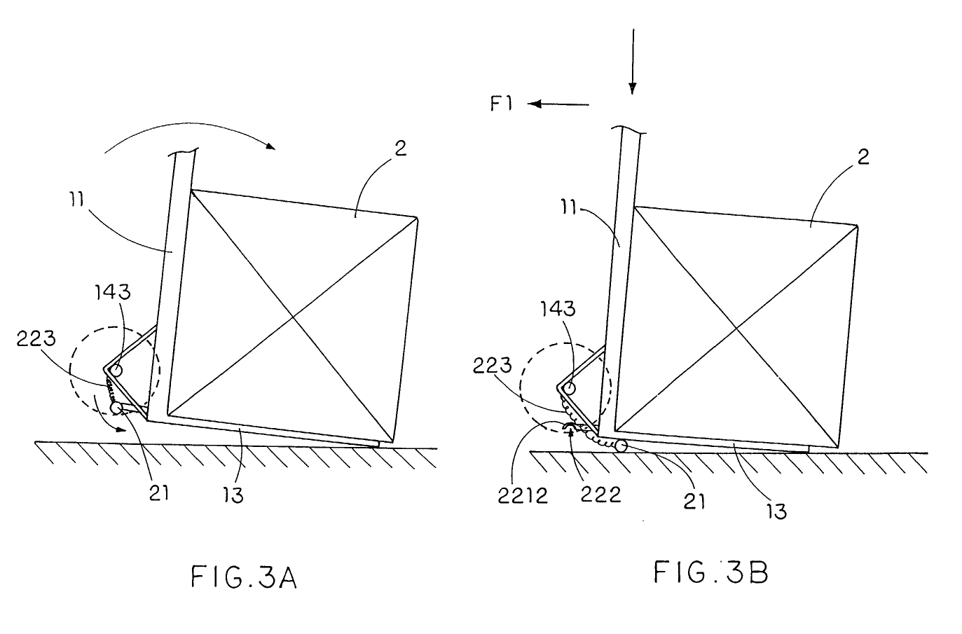

An object 2 to be transported is capable of loading on the ground platform 13 in such a manner that when a backward pulling force is applied on the handle frame 12 of the dolly frame 10, the dolly frame 10 is pivotally rotated to lift up the object 2, while a center of weight M of the object 2 is applied downwardly on the ground platform 13, As shown in FIG. 2, the pivot uplifting device 20 comprises a pivot arm 21 and a retaining unit 22 rearwardly extended from the dolly frame 10 to retain the pivot arm 21 in a normal position and to guide the pivot arm 21 to move at a pivot lifting position. In the normal position as shown in FIG. 3A, the pivot arm 21 is retained behind the ground platform 13, and in the pivot lifting position as shown in FIG. 3B, the pivot arm 21 is moved underneath the ground platform 13, so that the pivot arm 21 functions as a pivot P2 of the dolly frame 10 for pivotally lifting up the object 2 on the ground platform 13.

According to the first preferred embodiment, the pivot arm 21 is an elongated member transversely mounted to the dolly frame 10 wherein the pivot arm 21 is shaped and sized to be capable of being fittedly moved underneath the ground platform 13 while the object 2 is loaded thereon.

The retaining unit 22 comprises a sliding guider 221, having a holding groove 222, rearwardly extended from a rear edge portion 131 of the ground platform 13 for guiding the movement of the pivot arm 21 be limited between the normal position and the pivot lifting position, and a resilient device for providing an urging pressure against the pivot arm 21 to normally retain in the holding groove 222 at the normal position. According to the preferred embodiment, the resilient device comprises a pair of resilient elements 223 mounted to the ends of the pivot arm 21 for providing the urging pressure against the pivot arm 21, so as to normally retain the pivot arm 21 in the holding groove 222 at the normal position.

As shown in FIG. 2, the sliding guider 221 is constructed by a reinforcing panel 2211 substantially attached to the rear edge portion of the ground platform 13 and two spaced apart holding arms 2212, each having a curved shaped, integrally and rearwardly extended from the reinforcing panel 2211 to form the holding groove 222. Therefore, the user is able to apply a downward force on the pivot arm 21 at a position between the two holding arms 2212 to push it underneath the ground platform 13.

Alternatively, the reinforcing panel 2211 is adapted to be integrally and rearwardly extended from the rear edge portion of the ground platform 13 so as to enhance the strength of the sliding guider 221 and reduce the manufacturing process of attaching the reinforcing panel 2211 to the ground platform 13. In other words, the sliding guider 2211 can be built-in to the dolly 1 in order to provide an inherent pivot lifting feature of the dolly 1.

It is worth to mention that the reinforcing panel 2211 can be embodied to have two separated panels spacedly attached to the ground platform 13 wherein the two holding arms 2212 are integrally extended from the separated panels of the reinforcing panel 2211 respectively, so as to provide an operation opening between the two holding arms 2212 for the user to push the pivot arm 21 underneath the ground platform 13.

The resilient elements 223, according to the preferred embodiment as shown in FIGS. 1 and 2, are compression springs mounted between the dolly frame 10 and the pivot arm 21. Each of the resilient elements 223 has one end mounted to the wheel axle 143 of the wheel assembly 14 of the dolly frame and another end mounted to the respective end of the pivot arm 21 in such a manner that the resilient elements 223 provide a pulling force to pull the pivot arm 21 rearwardly with respect to the dolly frame 10 to be held in position in the holding groove 222.

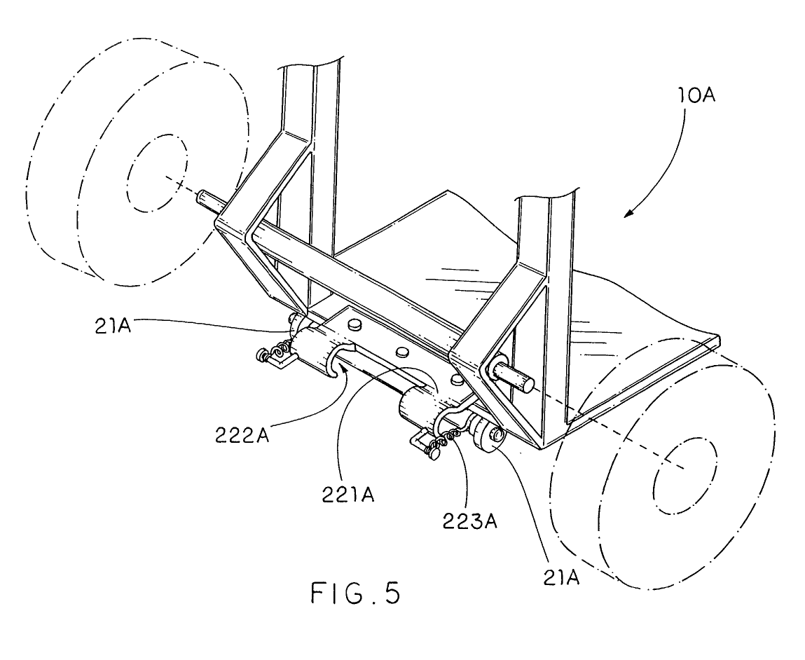

Alternatively, as shown in FIG. 5, the resilient elements 223A are mounted between the sliding guider 221A and the pivot arm 21A for providing an urging pressure against the pivot arm 21A, so as to normally urge and retain the pivot arm 21A received in the holding groove 222A of the sliding guider 221A. Accordingly, each of the resilient elements 223A has one end mounted to the holding arm 2212A of the sliding guider 221A and another end mounted to the respective end of the pivot arm 21A in such a manner that the resilient elements 223 pull the pivot arm 21 A rearwardly with respect to the dolly frame 10A to be held in position in the holding groove 222A.

According to the first preferred embodiment, the pivot uplifting device 20 further comprises a step member 23 extended from the pivot arm 21 at a position between the two holding arms 2212 and two auxiliary wheels 24 rotatably attached to two ends of the pivot arm 21 respectively. Therefore, the user is able to step on the step member 23 in order to push the pivot arm 21 underneath the ground platform 13. Moreover, the two auxiliary wheels 24 can enhance the pivotally lifting movement of the dolly frame 10 when the backward pulling force is applied on the handle frame 12 of the dolly frame 10.

In order to pivotally lift up the object 2 on the ground platform 13, the user may slightly push the dolly frame 10 frontwardly in such a manner that a receiving space is formed between the rear edge portion of the ground platform 13 and the ground. Then, the user's foot is able to step and push the pivot arm 21 downwardly toward the receiving space until the pivot arm 21 is positioned below the ground platform 13. By releasing the pushing force on the dolly frame 10, the pivot arm 21 is securely sandwiched and held between the ground platform 13 and the ground so that the pivot of the dolly frame 10 is shifted from the wheel assembly 14 to the pivot arm 21. Therefore, the user is able to apply a backward pulling force F on the handle frame 12 to pivotally lift up the object 2 on the ground platform 13.

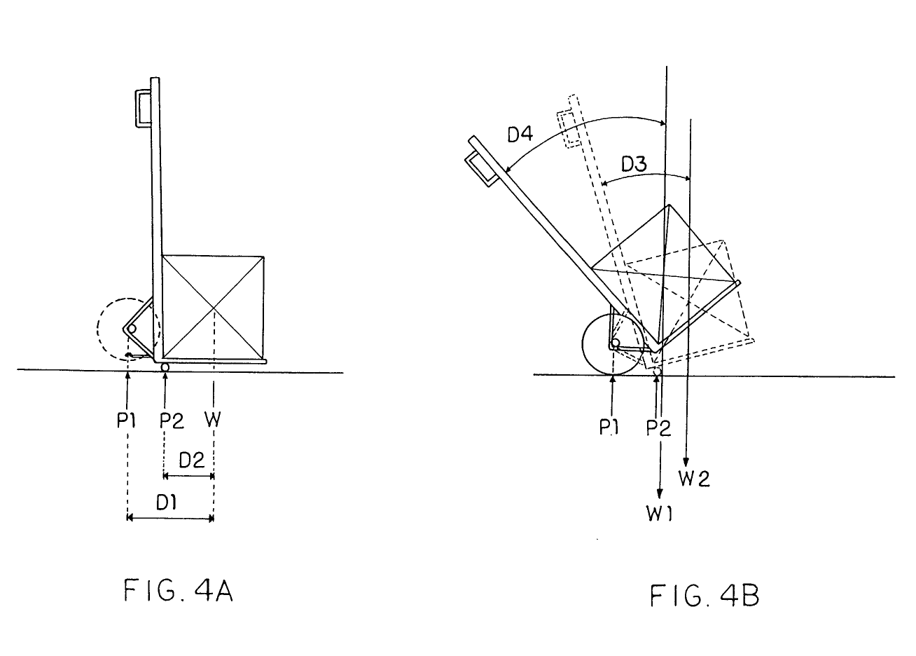

It is worth to mention that since the pivot P2 of the dolly frame 10 is shifted closer to the center of weight M of the object 2 so as to substantially reduce a pivot uplifting length D2 between the pivot and the center of weight M, the pulling force F required to pivotally lift up the object 2 is reduced, as shown in FIG. 4A. Moreover, the pivot angle required to pivotally rotate the dolly frame 10 is smaller than the pivot angle of the conventional dolly frame such that the control distance D4 for the dolly frame 10 of the present invention is shorter than the control distance D3 for the conventional dolly frame 10 so as to provide a better control of the dolly 1 when it is pivotally lifting up, as shown in FIG. 4B.

After the object 2 on the ground platform 13 is pivotally lifted up and supported by the wheel assembly 14, the pivot arm 21 losses a holding force that holds the pivot arm 21 underneath the ground platform 13. Then, the resilient elements 223 will pull the pivot arm 21 rearwardly to slide on the sliding guider 221 and back to the holding groove 222 of the retaining unit 20.

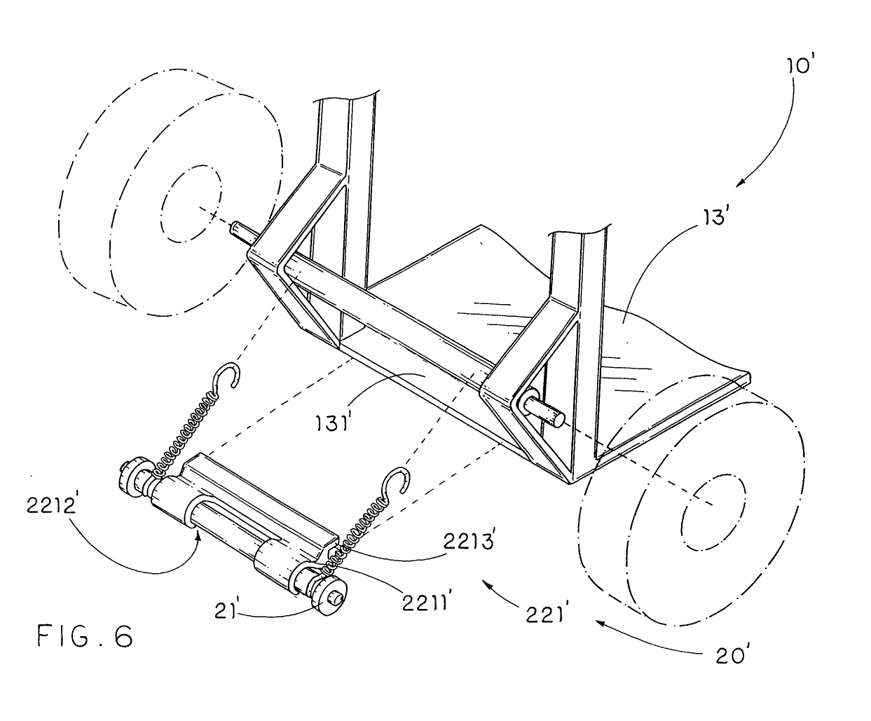

FIG. 6 illustrates an alternative mode of the pivot uplifting device 20′ wherein the sliding guider 21′ further comprises an edge holder 2213′, having a U-shaped cross section, extended frontwardly for securely mounting on the rear edge portion of the ground platform 13′.

Accordingly, the edge holder 2213′ is integrally and frontwardly extended from the reinforcing panel 2211′ in such a manner that the reinforcing panel 2211′ is adapted to be securely mounted to the rear edge portion of the ground platform 13′ so as to guide the pivot arm 21′ to slidably move from a position underneath the ground platform 13′ to the holding groove 2212′ of the sliding guider 221′.

It is worth to mention that the alternative mode illustrates that the pivot uplifting device 20′ is adapted to be installed into any conventional ground platform 13′ having the rear edge portion 131′. Therefore, the user is able to use of the pivot uplifting device 20′ to self-install into the conventional dolly for enhancing the pivotal lifting operation thereof.

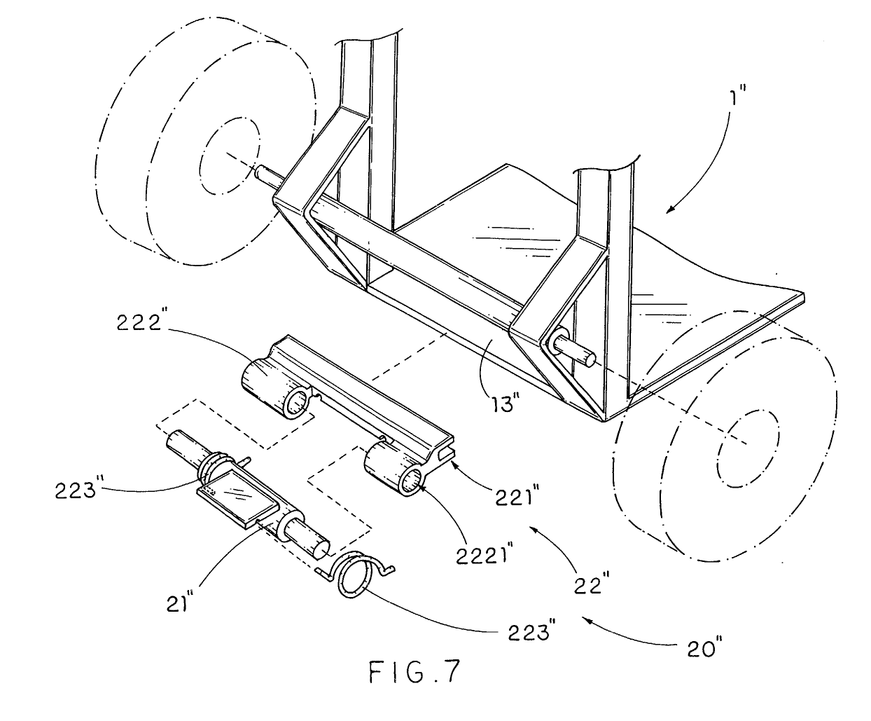

Referring to FIG. 7, the pivot uplifting device 20″ according to the second embodiment illustrates an alternative mode of the above first embodiment of the present invention, wherein the pivot arm 21″ is rotatably mounted to the rear edge portion of the ground platform 13″ so as to rotatably move between the normal position and the pivot lifting position.

As shown in FIG. 7, the retaining unit 22″ comprises an edge holder 221′ securely mounted to the rear edge portion of the ground platform 13″, a hinge joint 222″, having a transverse through slot 2221″, rearwardly extended from the edge holder 221″ to rotatably mount the pivot arm 21″ through the transverse through slot 2221″, and at least a resilient element 223″ mounted to the pivot arm 21″ for providing an urging pressure against the pivot arm 21″, so as to normally retain the pivot arm 21″ at the normal position.

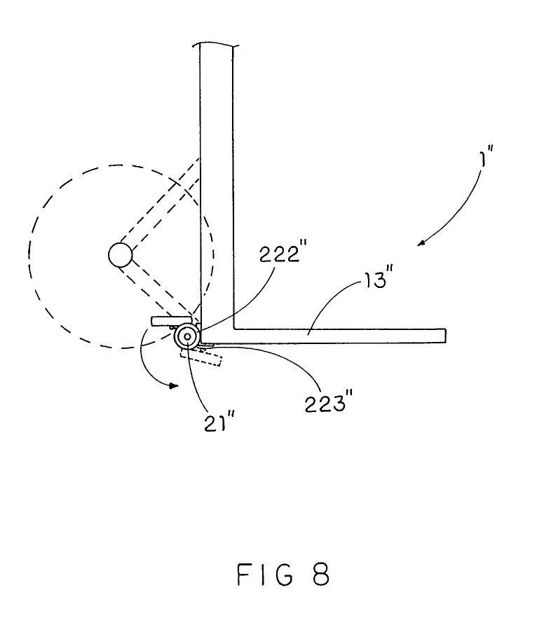

The pivot arm 21″ is rotatably mounted to the hinge joint 221″ wherein the pivot arm 21″ is rotatably fold forward to a position underneath the ground platform 13″ so as to lift up the rear portion of the ground platform 13″ at a predetermined height with respect to the ground, as shown in FIG. 8. Therefore, the pivot arm 21″ functions as the pivot of the dolly 1″ to pivotally lift up the object 2′ on the ground platform 13″.

The resilient element 223″, according to the second embodiment, is a coil spring coaxially mounted on the pivot arm 21″ for providing an urging pressure against the pivot arm 21″, so as to normally urge and retain the pivot arm 21″ at the normal position. Accordingly, the resilient element 223″ has two ends biasing against the pivot arm 21″ and the ground platform 13″ respectively in such a manner that the resilient element 223″ will rotatably pull the pivot arm backwardly to the normal position.

In view of above, the present invention substantially achieves the following distinctive features and innovative advantages:

(1) The pivot uplifting device for a dolly or hand truck substantially shifts a pivot point of the dolly closer to a center of weight of an object loaded on the dolly so as to facilitate the uplifting operation of the dolly with less effort.

(2) The pivot arm of the pivot uplifting device can be easily moved underneath a ground platform of the dolly and functioned as a pivot for substantially reduce a pivot uplifting length between the pivot arm and a center of weight of an object, so as to pivotally lifting up the object loaded on the ground platform.

(3) The pivot arm is normally retained behind the ground platform such that the pivot uplifting device will not interrupt the normal operation of the dolly while transporting the object.

(4) The pivot uplifting device for a dolly or hand truck does not require altering the original structural design of the dolly, so that the pivot uplifting device can be installed in all kinds of hand truck or conventional dolly having a ground platform.

What is claimed is:

1. A pivot uplifting device for a dolly which comprises a dolly frame comprising a supporting frame, a handle frame rearwardly extended from an upper portion of said supporting frame, a ground platform for loading a weight of an object thereon frontwardly extended from a bottom portion of said supporting frame, and a wheel assembly rotatably mounted behind said supporting frame, wherein said pivot uplifting device comprises:
a pivot arm; and
a retaining unit rearwardly extended from said dolly frame to retain said pivot arm in a normal position and to guide said pivot arm to move to a pivot lifting position, wherein in said normal position, said pivot is positioned behind said ground platform, and in said pivot lifting position, said pivot arm is moved underneath said ground platform rendering said pivot arm to function as a pivot for said dolly frame for pivotally lifting up said object on said ground platform.

2. The pivot uplifting device, as recited in claim 1, wherein said retaining unit comprises a sliding guider rearwardly constructed for extending from a rear edge portion of said ground platform to guide said pivot arm being moved between said normal position and said pivot lifting position and a resilient device mounted to said pivot arm for providing an urging pressure against said pivot arm, so as to normally retain said pivot arm in said normal position.

3. The pivot uplifting device, as recited in claim 2, wherein said sliding guider comprises a reinforcing panel for substantially attaching to said rear edge portion of said ground platform and two spaced apart holding arms, each having a curved shaped, integrally and rearwardly extended from said reinforcing panel to form a holding groove in such a manner that, in said normal position, said pivot arm is retained in said holding groove, and in said pivot lifting position, said pivot arm is slid downwardly along said reinforcing panel from said holding groove to a position underneath said ground platform.

4. The pivot uplifting device, as recited in claim 2, wherein said resilient device comprises at least a resilient element which has one end attached to said pivot arm and an opposed end adapted for securely attaching to said wheel assembly in such a manner that said resilient element normally provides a pulling force against said pivot arm to retain said pivot arm in said normal position.

5. The pivot uplifting device, as recited in claim 3, wherein said resilient device comprises at least a resilient element which has one end attached to said pivot arm and an opposed end adapted for securely attaching to said wheel assembly in such a manner that said resilient element normally provides a pulling force against said pivot arm to retain said pivot arm in said normal position.

6. The pivot uplifting device, as recited in claim 2, wherein said resilient device comprises at least a resilient element which has two ends attached to said pivot arm and said sliding guider respectively in such a manner that said resilient element normally provides a pulling force against said pivot arm to pull said pivot arm rearwardly to retain in said normal position.

7. The pivot uplifting device, as recited in claim 3, wherein said resilient device comprises at least a resilient element which has two ends attached to said pivot arm and said sliding guider respectively in such a manner that said resilient element normally provides a pulling force against said pivot arm to pull said pivot arm rearwardly to retain in said normal position.

8. The pivot uplifting device, as recited in claim 3, wherein said sliding guider further comprises an edge holder, having a U-shaped cross section, frontwardly extended from said reinforcing panel for securely attaching said rear edge portion of said ground platform, so as to substantially mount said reinforcing panel to said ground platform to guide said pivot arm slidably move from a position underneath said ground platform to said holding groove of said sliding guider.

9. The pivot uplifting device, as recited in claim 5, wherein said sliding guider further comprises an edge holder, having a U-shaped cross section, frontwardly extended from said reinforcing panel for securely attaching said rear edge portion of said ground platform, so as to substantially mount said reinforcing panel to said ground platform to guide said pivot arm slidably move from a position underneath said ground platform to said holding groove of said sliding guider.

10. The pivot uplifting device, as recited in claim 7, wherein said sliding guider further comprises an edge holder, having a U-shaped cross section, frontwardly extended from said reinforcing panel for securely attaching said rear edge portion of said ground platform, so as to substantially mount said reinforcing panel to said ground platform to guide said pivot arm slidably move from a position underneath said ground platform to said holding groove of said sliding guider.

11. The pivot uplifting device, as recited in claim 1, wherein said retaining unit comprises an edge holder for securely mounting to a rear edge portion of said ground platform, a hinge joint, having a transverse through slot, rearwardly extended from said edge holder to rotatably mount said pivot arm through said transverse through slot, and a resilient device mounted to said pivot arm for providing an urging pressure against said pivot arm so as to normally retain said pivot arm at said normal position.

12. The pivot uplifting device, as recited in claim 11, wherein said resilient device comprises at least a resilient element which is a coil spring coaxially mounted on said pivot arm wherein said resilient element has two ends biasing against said pivot arm and said ground platform respectively so as to rotatably pull said pivot arm backward to said normal position.

13. A dolly, comprising:
a dolly frame comprising a supporting frame, a handle frame rearwardly extended from an upper portion of said supporting frame, a ground platform, for loading a weight of an object thereon, frontwardly extended from a bottom portion of said supporting frame, and a wheel assembly rotatably mounted behind said supporting frame; and
a pivot uplifting device, comprising:
a pivot arm; and
a retaining unit rearwardly extended from said dolly frame to retain said pivot arm in a normal position and to guide said pivot arm to move at a pivot lifting position, wherein in said normal position, said pivot is positioned behind said ground platform, and in said pivot lifting position, said pivot arm is moved underneath said ground platform rendering said pivot arm to function as a pivot for said dolly frame for pivotally lifting up said object on said ground platform.

14. The dolly, as recited in claim 13, wherein said retaining unit comprises a sliding guider rearwardly extended from a rear edge portion of said ground platform to guide said pivot arm being moved between said normal position and said pivot lifting position and a resilient device mounted to said pivot arm for providing an urging pressure against said pivot arm, so as to normally retain said pivot arm in said normal position.

15. The dolly, as recited in claim 14, wherein said sliding guider comprises a reinforcing panel substantially attached to said rear edge portion of said ground platform and two spaced apart holding arms, each having a curved shaped, integrally and rearwardly extended from said reinforcing panel to form a holding groove in such a manner that, in said normal position, said pivot arm is retained in said holding groove, and in said pivot lifting position, said pivot arm is slid downwardly along said reinforcing panel from said holding groove to a position underneath said ground platform.

16. The dolly, as recited in claim 14, wherein said sliding guider comprises a reinforcing panel integrally affixed to and rearwardly extended from said rear edge portion of said ground platform and two spaced apart holding arms, each having a curved shaped, integrally and rearwardly extended from said reinforcing panel to form a holding groove in such a manner that, in said normal position, said pivot arm is retained in said holding groove, and in said pivot lifting position, said pivot arm is slid downwardly along said reinforcing panel from said holding groove to a position underneath said ground platform.

17. The dolly, as recited in claim 15, wherein said resilient device comprises at least a resilient element which has two ends attached to said pivot arm and said wheel assembly respectively in such a manner that said resilient element normally provides a pulling force against said pivot arm to pull said pivot arm rearwardly to retain in said normal position.

18. The dolly, as recited in claim 16, wherein said resilient device comprises at least a resilient element which has two ends attached to said pivot arm and said wheel assembly respectively in such a manner that said resilient element normally provides a pulling force against said pivot arm to pull said pivot arm rearwardly to retain in said normal position.

19. The dolly, as recited in claim 15, wherein said resilient device comprises at least a resilient element which has two ends attached to said pivot arm and said sliding guider in such a manner that said resilient element normally provides a pulling force against said pivot arm to pull said pivot arm rearwardly to retain in said normal position.

20. The dolly, as recited in claim 16, wherein said resilient device comprises at least a resilient element which has two ends attached to said pivot arm and said sliding guider in such a manner that said resilient element normally provides a pulling force against said pivot arm to pull said pivot arm rearwardly to retain in said normal position.

21. The dolly, as recited in claim 15, wherein said sliding guider further comprises an edge holder, having a U-shaped cross section, frontwardly extended from said reinforcing panel for securely attaching said rear edge portion of said ground platform, so as to substantially mount said reinforcing panel to said ground platform to guide said pivot arm slidably move from a position underneath said ground platform to said holding groove of said sliding guider.

22. The dolly, as recited in claim 13, wherein said retaining unit comprises an edge holder for securely mounting to a rear edge portion of said ground platform, a hinge joint, having a transverse through slot, rearwardly extended from said edge holder to rotatably mount said pivot arm through said transverse through slot, and a resilient device mounted to said pivot arm for providing an urging pressure against said pivot arm so as to normally retain said pivot arm at said normal position.

23. The dolly, as recited in claim 22, wherein said resilient device comprises at least a resilient element which is a coil spring coaxially mounted on said pivot arm wherein said resilient element has two ends biasing against said pivot arm and said ground platform respectively so as to rotatably pull said pivot arm backward to said normal position.
